(19) United States
(12) Patent Application Publication
(10) Pub. No.: US 2014/0123066 A1
(43) Pub. Date: May 1, 2014

(54) USER INTERFACE CONTROLS FOR SPECIFYING INTERVAL DATA

(71) Applicant: MICROSOFT CORPORATION, Redmond, WA (US)

(72) Inventors: Nigel Christopher William Wolters, Sammamish, WA (US); Adam Smolinski, North Bend, WA (US); Xue Song, Bellevue, WA (US)

(73) Assignee: MICROSOFT CORPORATION, Redmond, WA (US)

(21) Appl. No.: 13/663,880

(22) Filed: Oct. 30, 2012

(51) Int. Cl. G06F 3/048

(52) U.S. Cl. 715/833

(57) ABSTRACT

A computer-implemented method for specifying interval data includes displaying, via a user interface, a slider row of user select buttons, the slider row being configured to support selection of a range term of the interval data, receiving first data indicative of a first touch input via the user interface directed to a respective one of the user select buttons to specify a value for the range term, displaying, via the user interface, a plurality of user select range composition buttons, receiving second data indicative of a second touch input via the user interface directed to a respective one of the plurality of user select range composition buttons to determine whether the interval data includes a further range term to be specified, and storing, with a processor, the interval data in a memory in accordance with the first data and the second data.

### BACKGROUND OF THE DISCLOSURE

### Brief Description of Related Technology

Value intervals are used in many software applications to provide data that falls within the value interval. For example, business intelligence applications often include a dashboard to display data filtered by the value interval. Time intervals are one type of interval relevant to reporting and analytics. The time interval defines a time period over which data may be filtered and analyzed to present information specific to the defined time range.

Value intervals are often specified via graphical user interfaces, such as touch-based user interfaces. Touchscreens are used to select endpoints for the value interval. In time intervals, the user interface commonly displays a calendar from which dates or times may be selected. Other user interfaces present scroll wheels to enable a user to select a month, day, hour, or minute of an endpoint. After selecting a value for the first endpoint, users scroll to another location on the scroll wheel to select a value for the other endpoint.

### SUMMARY OF THE DISCLOSURE

Methods, apparatus, and computer program products are directed to user interfaces for specifying interval data. The user interfaces may be configured to determine a number of range terms to be specified for the interval data. The number of range terms in the interval data may thus vary.

In accordance with one aspect of the disclosure, data indicative of first and second touch inputs is received via a user interface to specify interval data. The first touch input may be directed to specifying a value for a range term. The second touch input may be directed to determining whether the interval data includes a further range term to be specified via the user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWING FIGURES

For a more complete understanding of the disclosure, reference should be made to the following detailed description and accompanying drawing figures, in which like reference numerals identify like elements in the figures.

FIG. 1 is a block diagram of an exemplary system having apparatus configured to specify interval data in accordance with one embodiment.

FIG. 2 is a flow diagram of an exemplary computer-implemented method to specify interval data in accordance with one embodiment.

FIG. 3 is a block diagram of a computing environment in accordance with one embodiment for implementation of one or more of the disclosed methods and apparatus.

FIGS. 4 and 5 are exemplary user interfaces generated, rendered, or presented in accordance with one embodiment.

While the disclosed systems and methods are susceptible of embodiments in various forms, there are illustrated in the drawing (and will hereafter be described) specific embodiments of the invention, with the understanding that the disclosure is intended to be illustrative, and is not intended to limit the invention to the specific embodiments described and illustrated herein.

### DETAILED DESCRIPTION

The disclosed methods and apparatus are directed to user interfaces configured to specify interval data. The user interfaces may include one or more slider rows to facilitate selection of values for range terms of the interval data. The slider rows may be adjustable to present varying ranges of values for selection. In some cases, the units or granularity of the value ranges may also be adjusted (e.g., a zoom in/out via a user interface gesture, such as a pinch). The slider row(s) provide a convenient mechanism for specifying a range term (e.g., endpoint) with one or more parts (e.g., May 14, 2008). In addition to the slider row(s), the user interfaces may have a number of composition control buttons directed to constructing one or more range terms for the interval data. The composition control buttons may be directed to committing a value and/or range term to the interval data, and/or to composing the interval data from one or more additional range terms. A number of different composition control buttons may be provided via the user interface to facilitate different types of range terms for the interval data.

The disclosed methods and apparatus may be useful for specifying interval data with varying numbers of range terms. Both singular and complex ranges may be specified. For example, the user interface controls of the disclosed methods and apparatus may support the specification of interval data involving a concatenation of multiple ranges. The interval data may thus specify a composite range, e.g., a range having multiple pairs of interval endpoints. The user interface controls may also support the specification of interval data via a single range term, such as May 2008. The single range term may be set forth at varying levels of granularity (e.g., month, year, etc.).

The user interface controls of the disclosed methods and apparatus may be configured to consume a small amount of space, e.g., interface area, despite providing the flexibility to support such singular and complex ranges. For example, the slider row(s) may avoid the presentation of multiple scroll wheels. The slider row(s) may also avoid forcing a user to proceed through a number of dropdown menus.

The user interface controls of the disclosed methods and apparatus may be useful in connection with controlling tablets, smartphones, or other mobile devices or other apparatus. The mobile devices or apparatus may have a touch-based user interface via which the user interface controls are presented to support specification of the interval data.

Although described in the context of time intervals, the disclosed methods and systems may be used with a wide variety of value intervals. The interval data may be used in a variety of different software contexts and environments. For example, the disclosed methods and systems are well suited for use with other types of intervals, such as weight and distance intervals. In business intelligence examples, other types of intervals or ranges may also be used to filter and analyze data as appropriate, including geographical regions, product categories, job types, as well as any other data or information suitable for value intervals. These and other types of intervals may be specified by range terms having values that specify an alphabetical, spatial, or other order or arrangement. For example, a geographic interval may specify a range of cities within a given state with endpoints of the range or interval corresponding with the latitudes of selected cities. Alternatively or additionally, the geographic interval may be specified via a single range term, e.g., a range term value that identifies a state to specify a range of cities corresponding with all cities within the identified state.

Although described in connection with business intelligence software or systems, the disclosed methods and apparatus are not limited to a particular application or software environment. For example, the disclosed methods and apparatus are not limited to using the interval data to filter or query a database to populate a business intelligence report. The disclosed methods and apparatus may be used to specify interval data for a variety of different purposes other than filtering or queries. For example, the interval data may be used to characterize the time period associated with a calendar item, or to perform a calculation, such as a summation of individual distances (or other types of ranges).

Touch-based user interfaces may specify the interval data through the use of a pointer, finger, or other touch-based device or tool. The manner in which the touch-based inputs are made may vary. For example, a touch-based input need not touch the screen or display presenting a graphical or other visual component of the user interface, and may instead involve a touch directed to a track pad or other device that forms part of a composite user interface. Touch-based inputs may thus involve the use of a mouse or other pointer device. The touch-based user interfaces may include or involve a multi-touch functionality that provides users with the ability to apply multiple-finger touches or gestures simultaneously to send one or more commands.

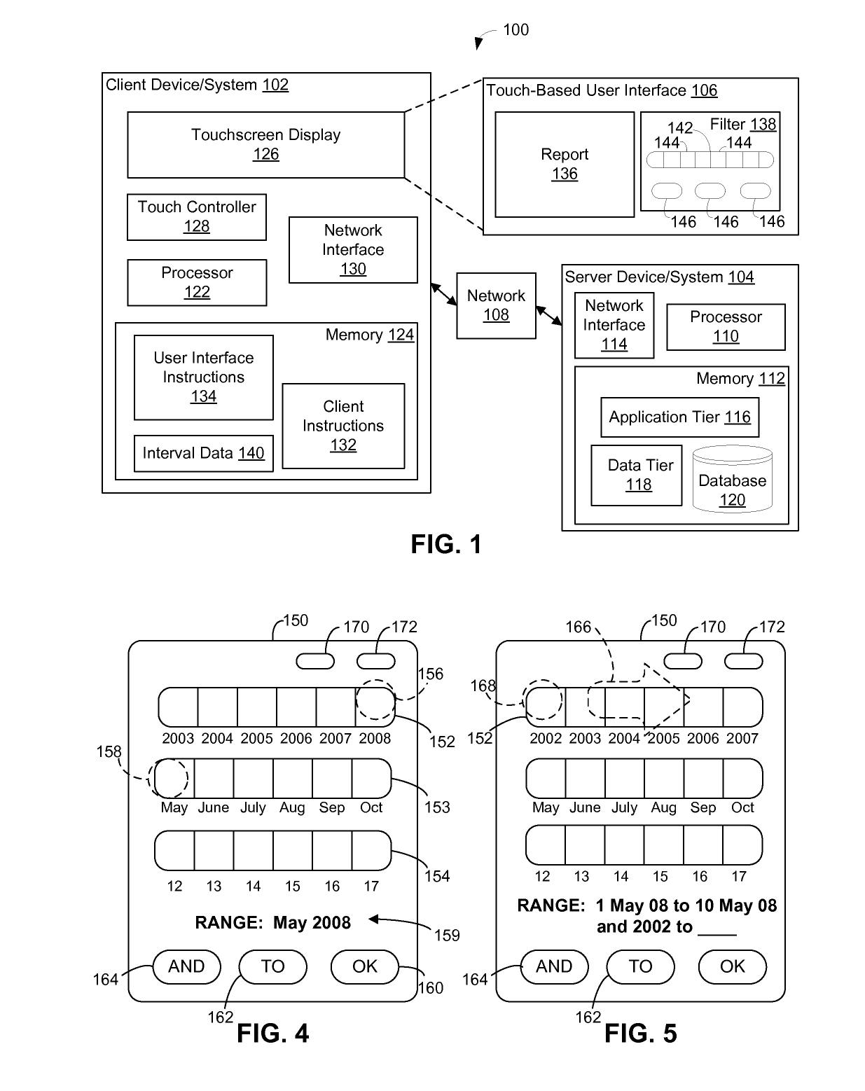

FIG. 1 depicts one example of a system 100 in which interval data is specified in accordance with one embodiment. The system 100 may include any number of computing devices or systems. In this example, the system 100 includes a client device 102 and a server device 104. The client device 102 may be a mobile client device. The client device 102 is configured to present a user interface 106 for the system 100. The user interface 106 may be configured as a touch-based user interface. The user interface 106 may be configured to receive one or more touch inputs to specify interval data for the system 100. The touch inputs may determine a number of range terms for the interval data, as described below. The interval data may be delivered to the server device 104 via a network 108 to support the implementation of a software application or other function of the system 100. The functionality may involve displaying, processing, or otherwise using the interval data to perform any task of the system 100. For example, the interval data may be used to define one or more filter or query parameters to obtain data from a database. The interval data may be applied or used in a variety of ways, as the nature of the task may vary. The functionality provided by the client device 102 and the server device 104 may be integrated to any desired extent.

The server device 104 includes a number of software and hardware components to implement a software application or other software functionality. In this example, the server device 104 includes a processor 110 and a number of components coupled thereto, or in communication therewith, including a memory 112, and a network interface 114. The processor 110 may be configured to implement instructions stored in the memory 112. The instructions may include application tier instructions 116 (or application tier module) and data tier instruction 118 (or data tier module). The application tier instructions 116 may define one or more functions of the system 100. In business intelligence examples, the functions may include or involve the generation of a report to be presented to a user of the client device 102 or other device of the system 100 in communication with the server device 102. The data tier instructions 118 may be configured to retrieve, store, and otherwise manage data to be used during implementation of the application tier instructions 116. In this example, the memory 112 also includes a database 120 in which the data managed by the data tier instructions 118 is stored. The database 120 need not be integrated in the memory 112. For example, the database 120 may be located remotely from the memory 112.

The client device 102 is configured to communicate with the server device 104 to provide the functionality of the software application to a user. The client device 102 includes a number of software and hardware components to support the presentation of the functionality to the user. In this example, the client device 102 includes a processor 122 and a number of components coupled thereto, or in communication therewith, including a memory 124, a display 126, a touch controller 128, and a network interface 130. The display 126 may be a touchscreen display to receive touch-based inputs provided by the user while presenting the user interface 106. For example, the display 126 may be an liquid crystal display (LCD) having one or more transducers for capturing the touch inputs. Data indicative of the touch-based inputs may be captured by the touch controller 128. The touch controller 128 may alternatively or additionally be configured to capture data indicative of touch-based inputs provided via a different touch sensitive device, such as a touch pad. Thus, the display 126 need not be touch-sensitive. The touch controller 128 may be integrated with the processor 122 to any desired extent. For example, the processor 122 and the touch controller 128 may be disposed on a single processing chip, such as a system on a chip or an application-specific integrated circuit (ASIC) chip. The services and data of the server device 104 may be received by the client device 102 via a client proxy arrangement.

The processor 122 may implement instructions stored in the memory 124. The processor 122 is used to implement one or more aspects of the user interface controls of the disclosed methods and apparatus. The memory 124 may store instructions to direct the processor 122 in the implementation of the user interface controls. In this example, the instructions include client instructions 132 and user interface instructions 134. The client instructions 132 may be configured based on instructions or other data received from the server device 104 via the network interface 130. For example, the application tier instructions 116 may direct the server device 104 to provide data indicative of an application function or module to be implemented on the client side of the system 100. Such data may be stored in the memory 124 as a module or other component of the client instructions 132. The user interface instructions 134 may be implemented by the processor 122 to render the user interface 106 and/or receive data via the touch controller 126. The user interface instructions 134 may be integrated with the client instructions 132 to any desired extent. For example, the user interface instructions 134 may include one or more methods called during implementation of the client instructions 132, and/or vice versa.

In the example of FIG. 1, the client instructions 132 may be implemented by the processor 122 to render a report 136 or other element of the user interface 106. For example, the client instructions 132 may be configured to determine data, information, or other content to be presented in the report 136. The user interface instructions 134 may include one or more methods for determining the format, layout, and presentation aspects of the report 136. In this example, the content of the report 136 is determined by a filter 138, a visual representation of which is presented via the user interface 106. The visual representation of the filter 138 may be rendered via the user interface instructions 134, while the functionality of the filter 138 may be configured or established via the client instructions 132. The filter 138 is displayed via the user interface 106 to allow a user to specify interval data 140 for use by the system 100. The user interface instructions 134 may be configured to render the filter 138. The client instructions 132 and the user interface instructions 134 may thus be implemented by the processor 122 to support the receipt and/or specification of the interval data 140.

The interval data 140 used or generated by the client device 102 may be stored in the memory 136 as shown. Such storage may occur before or in connection with the transmission of the interval data 140 to the server device 104 for processing. For example, the server device 104 may use the interval data to query the database 120 via a database query generated or provided during implementation of the data tier instructions 118.

During operation, the processor 122 is directed and configured to execute the user interface instructions 134 to render the user interface 106. The processor 122 may direct the display 126 to display the user interface 106. In this example, the user interface 106 includes a slider row 142 in the filter 138 configured to support selection of one or more range terms of the interval data 140. In an alternative embodiment, the slider row 142 is one of a plurality of slider rows. The slider row 142 (or each slider row) includes a set of user select buttons 144. A tap or other touch input selection of a respective one of the user select buttons 144 allows a user to incorporate a value into the current range term being composed by the filter 138. The processor 122 receives data indicative of the touch input directed to the respective one of the user select buttons 144 to specify a value for the range term in accordance with the respective one of the user select buttons 144.

The slider row 142 may be adjustable such that the values presented for selection by the user select buttons 144 may change. For example, the slider row 142 may display the six months ranging from February through July, and then be adjusted to display the six months ranging from July through December. A gesture such as a swipe to the left or right along the slider row 142 may be used to scroll through other values available for selection. In this example, other gestures may be used to adjust the units or granularity of the values presented by the slider row 142. For example, a pinch or other gesture may be used to change the granularity of the values from months to years. A reverse pinch may then be used to change the granularity in the other direction, e.g., from months to days. A single slider row may thus be used to specify different components of a range term. Further details regarding the adjustability of the slider row 142 are set forth in connection with the examples of FIGS. 4 and 5. The adjustability of the slider row 142 may be implemented via user interface interactions other than gestures, such as a mouse drag or other pointer motion, use of a scroll wheel, and double-click interactions. Such interactions may be combined with yet other interactions to implement an adjustment in the other direction (e.g., holding down a Control key while double clicking).

The user interface 106 also includes a plurality of range control buttons 146 to be selected by a user. The range control buttons 146 may be directed to compose or commit a range term (e.g., 1 May 2008) for use in the interval data 140. One or more of the range control buttons 146 may be configured to allow a user to compose the range terms in a desired arrangement, and may thus be referred to as range composition buttons. By providing the user to control the composition and/or arrangement of the range terms, the interval data 140 may be established via a varying number of range terms. For example, the interval data may be specified via a single range term (e.g., May 2008), via a pair of range terms that act as endpoints of the interval (e.g., 1 May 2008 to 25 May 2008), and via composite ranges. The interval data for a composite range may concatenate any number of ranges (e.g., May 2008 and May 2009). The range terms in the composite range may be arranged as single range terms and/or in range term pairs. For example, a composite range may be specified that includes a concatenation of both types of range term arrangements (e.g., May 2008 and 2009 to 2010).

In the embodiment of FIG. 1, each range control button 146 is configured to control or facilitate the composition of the range terms of the interval data 140. The range control buttons 146 may be configured to specify a relationship, transition, logical operator, or other operator for the composition. For example, one of the range control buttons 146 may be configured as a “TO” operator to specify that the current range term is a first endpoint of a pair of range terms. The “TO” operator establishes a relationship between successively specified range terms. The label for this relationship-establishing operator may vary. For example, a hyphen, dash, or another preposition (e.g., “through”) may be used.

Another one of the range control buttons 146 may be configured as a conjunctive operator, such as an “AND” operator or an “OR” operator. For example, the conjunctive operator may be configured to combine multiple ranges into a composite range. In a two range example, a first range may be specified via one or more touch inputs directed to the slider row 142, which is then followed by a touch input directed to the “AND” operator, and further touch inputs to the slider row 142 to specify the second range.

Upon completing the entry of the range term or terms, another one of the range control buttons 146 may be configured to commit the entire expression for use in the interval data 140. For example, the range control buttons 146 may include a checkmark or “OK” button to be selected when the user is finished with entry of the range term(s).

Through the above-described range control buttons 146, a user may determine whether the interval data 140 includes a further range term to be specified. As described above, one or more of the range control buttons 146 may be range composition control buttons configured to create a further range term for the interval data 140. In some cases, the range composition control button is configured to support concatenation of multiple ranges. In other cases, the range composition control button is configured to establish a relationship between the range term and the further range term. Using the range composition control buttons may allow a user to provide touch inputs to specify the interval data 140 via a single range term, a pair of range terms, multiple pairs of range terms, or various combinations thereof. Alternative, additional, or fewer range composition control buttons may be included.

The system 100 is configured to specify the interval data 140 for use by the client device 102 and/or the server device 104. In the embodiment of FIG. 1, the user interface instructions 134 may direct the processor 122 to provide the interval data 140 to the server device 104 for processing. For example, the processor 122 may send the interval data 140 to the server device 104 to enable the processor 110 to query the database 120. The results of the query may then be incorporated into the report 136 to be presented via the user interface 106. In another example, the interval data 140 is processed or otherwise used during implementation of the application tier instructions 116 on the server side. Alternatively or additionally, the interval data 140 is processed or otherwise used on the client side during implementation of the client instructions 132 by the processor 122. The data used or generated by the client device 102 may be stored in the database 120 of the server device 104. The manner in which the interval data 140 is used may vary.

FIG. 4 depicts one example of a user interface control 150 rendered, displayed, or otherwise generated by the disclosed methods and apparatus. For instance, the user interface control 150 may be rendered via the execution of the user interface instructions 134 (FIG. 1) by the processor 122 (FIG. 1). In this example, the user interface control 150 includes multiple slider rows 152-154 directed to different granularity levels or units for the range terms. Any number of slider rows may be included. In this example, the slider rows 152-154 are directed to specifying a year, a month, and a date of a range term, respectively. Data indicative of touch inputs 156 and 158 have been captured and received to specify a year value (“2008”) and a month value (“May”), respectively.

The selected values are then displayed in the user interface control 150 in a range term display area 159 below the slider row 154. In some cases, the user interface control 150 may be configured to allow a user to scroll or otherwise navigate through the values presented in the range term display area 159. Such navigation may be useful in the event that the range term display area 159 is not large enough to display the entire composition of the interval data. The navigation may be implemented via swiping or other gestures. Alternatively or additionally, one or more user interface interactions may be used to display the entire composition. For example, a user may hold a finger or other stylus down on the range term display area 159 to display a tooltip or other pop-up that shows the entire composition.

In other embodiments involving different types of intervals, one or more slider rows may be directed to specifying categories or groups to filter down the values presented by one or more lower rows. In geographic interval examples, a top slider row may present a number of states for selection, a middle slider row may present a number of counties for selection, and a lower slider row may present the cities within a selected state and/or county. The higher slider rows may thus be used for scoping. Alternatively or additionally, the higher slider rows may be selected to define a range term at a higher level of granularity (e.g., the entire state).

The number, layout, arrangement, and other characteristics of the slider rows may vary with the application or context in which the user interface control 150 is generated. For example, an alternative layout of slider rows may dispose the rows side-by-side. Side-by-side layouts may be useful in an interval selection in which the range term values are specified via, for instance, names. For example, a left-side slider row is directed to specifying a first or given name of a range term and a right-side slider row is directed to specifying a last or family name of the range term. Selection of a first name may filter or scope the list of available last names presented via the right-side slider row. Once the first/last name pair is specified, a composition control button (e.g., AND) may be selected to specify a further name for another range term.

At this point in the interval data entry process, the user interface control 150 provides a user with the opportunity to enter further value data or control the arrangement or composition of range terms. The user may select an “OK” range control button 160 to commit the value data as a single range term (“May 2008”). Alternatively, the user may select a “TO” range composition button 162 to compose a pair of range terms, with the previously entered value data as a first endpoint. The user may alternatively select an “AND” range composition button 164 to arrange a composition of range terms involving multiple range term pairs or other range terms. For example, the “AND” range composition button 164 may be used to concatenate the current single range term (“May 2008”) with another single range term (“June 2005”), in which case the interval data is representative of the combination of the two ranges (“May 2008” and “June 2005”).

FIG. 5 depicts the user interface control 150 after an adjustment to the slider row 152 and further entry of range term value data. Range data indicative of a pair of endpoints has been specified (“1 May 2008 to 10 May 2008”). The range term value data presents an example of the concatenation of multiple ranges in a composite or complex interval, insofar as the interval defined by the pair of endpoints is combined with a second range via the selection of the “AND” range composition button 164. In the process of entering value data for the second range, data indicative of a swipe gesture input 166 is captured and received to adjust the values depicted via the buttons of the slider row 152. In this example, the swipe gesture input 166 is directed to the right as shown to reveal earlier years for selection. Data indicative of a touch input 168 is then captured and received to specify the year “2002”. Selection of the “TO” range composition button 162 is then be used to specify another year as an endpoint to the second range. As shown in this example, the granularity level or units of the range terms may vary between components. The range terms in the first range are specified at the date level, while the range terms in the second range are specified at the year level. The user interface controls of the disclosed methods and apparatus may thus flexibly support a wide variety of range terms for a respective filter operation.

The user interface control 150 shown in FIGS. 4 and 5 may also include further control buttons directed to various functions. In this example, a control button 170 may be configured to provide eraser or undo functionality, and a control button 172 may be configured to cancel the data entry process. Alternative, additional, or fewer control buttons may be provided. For example, a control button may be included to expand or contract the user interface control 150 to increase or decrease the number of elements displayed. For instance, the number of slider rows may be increased or decreased.

The slider rows 152-154 may be adjustable in a variety of ways in addition to adjustments to the range of values displayed. For example, one or more of the slider rows 152-154 may be adjusted to change the scale of the values presented. A pinch or other gesture may be used to modify the granularity level, e.g., from years to decades. The size of each user select button may also be adjusted via such gestures. Such gestures may be used in embodiments in which the user interface control 150 includes only a single slider row. Users may then zoom in or out to reveal the different levels of granularity available for selection. Such zooming may include modifications to the demarcations (e.g., lines) between the units move horizontally to indicate different granularity (e.g. year units are wider than month units). The accompanying text may fade in and out to show the appropriate unit (e.g. month values fade to year values). Further details regarding exemplary embodiments in which multi-touch gestures are used to modify the granularity of a slider row are provided in U.S. Patent Publication No. 2011/0283188 (“Value Interval Selection on Multi-Touch Devices”), the entire disclosure of which is hereby incorporated by reference.

With reference again to FIG. 1, the construction, configuration, and other characteristics of the client device 102 may vary. The client device 102 may include any computer or other processing device that executes or displays information associated with one or more applications. The applications need not be executed in a client-server architecture or environment. For instance, the client device 102 may be a tablet, smartphone, or other mobile computing device. The touch sensitivity of the client device 102 may be based on any now known or hereafter developed technology. For example, the client device 102 may recognize touch inputs based on capacitive, resistive, pressure, acoustic, and/or other measurements.

The above-described user interface controls may be useful in connection with devices having limited display size. The user interface controls of the disclosed methods and apparatus are not limited to any particular display interface size. In some embodiments, the client device 102 includes a multi-touch display interface capable of recognizing multiple, concurrent touch inputs. The construction, configuration, and other characteristics of the touch display interface may vary.

The construction, configuration, and other characteristics of the server device 104 may also vary. The server device 104 may include any number of computing devices. For example, functionality associated with the application tier instructions 116 may be implemented on an application server computer, while functionality associated with the data tier instructions 118 may be implemented on a database management server computer.

The disclosed methods and apparatus may be implemented in a networked or other distributed environment. In this example, the client device 102 and the server device 104 communicate with one another via the network 108. The network 108 may include any wired or wireless communication connection, including, for instance, the Internet, an extranet, a local area network, or any other network or network type. The network 108, as well as any computing devices thereof, may be configured as components of the system 100. The network 108 may establish a communication link between the client device 102 and the server device 104 via a variety of different communication protocols or technologies.

The architecture of the system 100 may vary. The implementation of the client device 102 and/or the server device 104 may be distributed over any number of computing devices. The system 100 need not be implemented in a client-server architecture. In some cases, the disclosed methods and apparatus are implemented without the network 108 and/or the server device 104. For example, the disclosed methods and apparatus may be implemented locally via the client device 102.

The system 100 may include any number of additional processors, computers, devices, or other systems to generate various user interfaces or environments, including, for instance, separate development, end-user, or administrative environments for the product development system 102, the test development system 104, and/or the software system 116.

The memory 112 and/or the memory 124 may include any number of data storage devices of varying types or other data stores or memories. Computer-readable instructions for each of the above-described modules, components, or elements of the client device 102 and the server device 104 may be stored in any manner across the data storage devices. Data generated or resulting from the execution of such instructions may also be stored in any manner across the data storage devices. For example, the data storage devices may include one or more data stores in which data is stored during or after various operations.

The processor 110 and/or the processor 122 may include any number of processors or processing systems. The processors or processing systems may be distributed among or across any number of computing devices, including, for instance, one or more server devices and one or more client devices.

The user interface 106 may include any number of user interface components integrated to a varying extent. For example, the user interface 106 may include a display component and a touch input component separate or spaced from the display component. The operation of such components may be coupled via the processor 122 and/or the touch controller 128 to coordinate the input and output functions of the client device 102. The user interface 106 may include multiple display components and/or multiple touch input components.

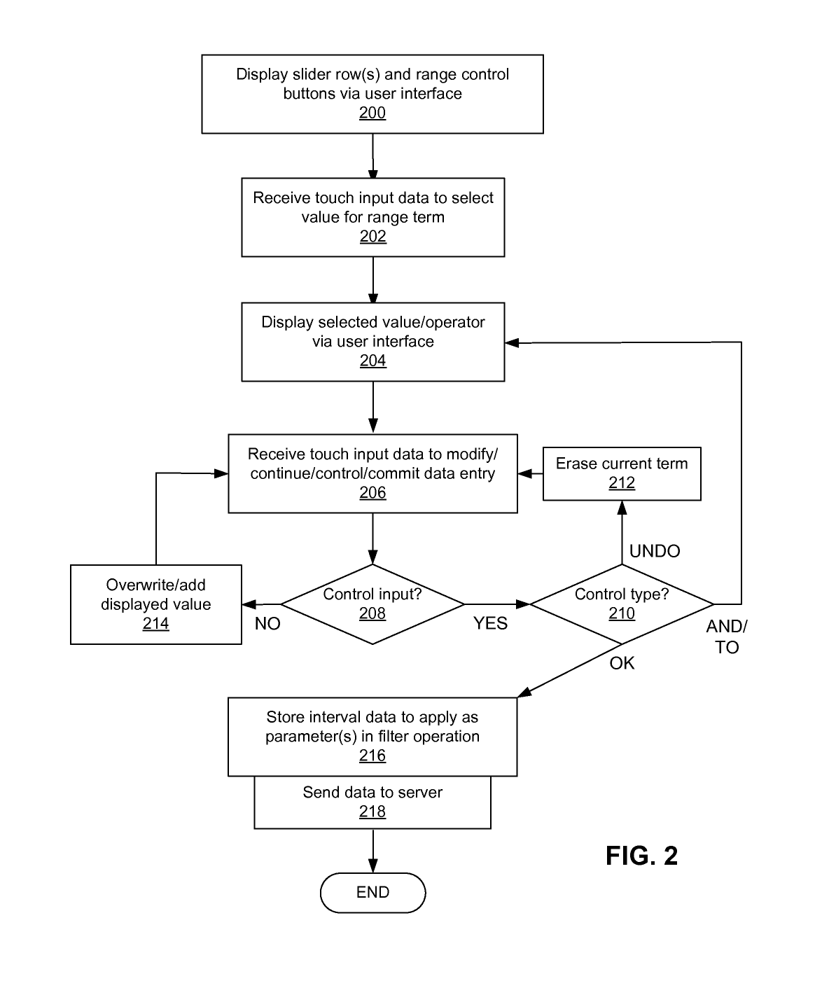

FIG. 2 depicts an exemplary method for specifying interval data via a user interface. The method is computer-implemented. For example, the processor 122 shown in FIG. 1 may be configured to implement one or more of the acts of the method. The implementation of each act may be directed by respective computer-readable instructions executed by the processor 122 and/or another processor or processing system.

The method may begin with any number of acts directed to the presentation, analysis, or other processing of data. The processing may be implemented in the context of a software application, such as a business intelligence application or other analytical business application. In some cases, the method is implemented in connection with queries run against a database. However, the method need not include any database management or data processing acts. The method may begin with any trigger or event that calls for the specification of interval data, and is not limited to any particular type of interval.

In the embodiment of FIG. 2, the method begins with an act 200 in which one or more slider rows are displayed via a user interface. Each slider row includes a number of buttons that may be selected by a user. Each slider row is configured to support selection of a range term of the interval data. In some cases, the user interface presents a plurality of slider rows, in which case each slider row is directed to specifying a different level of granularity for the interval data. For example, one slider row may be directed to specifying a year of a range term, while another slider row is directed to specifying a month of the range term.

In this example, a plurality of range control buttons is also displayed via the user interface at this time. In an alternative embodiment, one or more of the range control buttons are displayed in a status- or context-sensitive manner. For example, the display of a range composition control button (e.g., a transition or conjunctive control, such as “AND” or “TO”) may be delayed until a range term has been specified. The user interface controls of the disclosed methods and apparatus may thus adjust to the status of the data entry.

In act 202, touch input data is received indicative of a touch input provided via the user interface. The touch input is directed to a respective one of the user select buttons in one of the slider rows to specify a value for the range term. The specified value corresponds with the value displayed via the respective user select button. The specified value may then be displayed via the user interface in act 204 upon receipt and processing of the touch input data.

After a value has been specified for the range term, further touch input data is received in act 206. The touch input data may be continuing the data entry initiated in the act 202. For example, the previous touch input data may specify a month of the range term while the current touch input data may specify a year of the range term. Alternatively, the touch input data may be directed to controlling the data entry process by either committing the previously specified range term and/or composing further range terms. A decision block 208 accordingly determines whether the current touch input data is a control input. If so, control passes to another decision block 210 to determine the type of range control selected by the user. In this example, a user may select an “UNDO” or other cancellation control element to erase a current range term (or range term value) in an act 212, after which control returns to the act 206 to await receipt of further touch input data. A previous value selected may be alternatively overwritten if the touch input data is instead representative of a further range term value, in which case control passes to an act 214. An overwrite of the currently displayed range term value may occur if the range term is highlighted or otherwise active. For example, a current month (e.g., “May”) may be replaced by a subsequent month selection (e.g., “June”). In some cases, the act 214 may be configured to automatically replace a range term value with the subsequent selection based on whether the granularity or unit of the selection. If no range term value is highlighted or active, then the act 214 may be involve adding the selected value to the range term or a successive range term.

If a range composition control is selected, such as an “AND” operator or a “TO” operator, then control returns to the act 204 to display the selected operator along with the previously entered range term values to support further composition of the interval data. Further range term values may then be specified via receipt of further touch input data in accordance with the act 206.

The composition of the interval data and specification of the range term values may continue via the loop shown until all of the range terms are specified. A range control button configured to commit the range term(s) without further data entry is then selected by the user. For example, the range control buttons may include an “OK” button or a checkmark button for a user to select upon completion of the data entry. Once selected, control passes from the decision block 210 to an act 216, in which the interval data is stored in a memory. In this example, the interval data is applied as a parameter in a filter operation, such as a database query. Storage of the interval data may include delivery of the interval data in an act 218 to, for instance, a server or other computing device.

Implementation of the decision block 208 and the decision block 210 allows the functionality of the range control buttons to control further specification of interval data. As described above, the range control buttons are selected by the user to determine whether the interval data includes a further range term to be specified. The decision block 210 may then determine whether the selected range control button is configured to commit the value to the interval data, control the composition or arrangement of range terms by creating a further range term for the interval data, supporting the concatenation of multiple ranges, or otherwise establishing a relationship between range terms.

The order of the acts of the method may vary. For example, the selected range terms and/or operators may be stored on the fly rather than after a user has selected a control button to commit the range terms for the interval data.

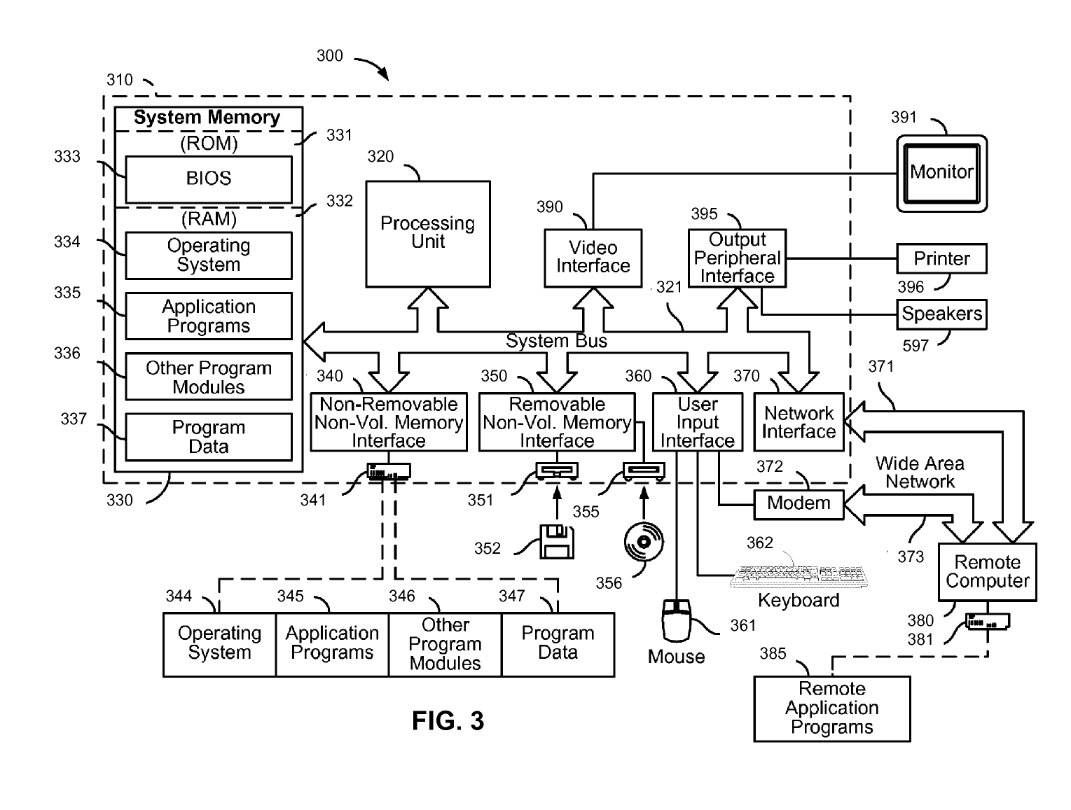

With reference to FIG. 3, an exemplary computing environment 300 may be used to implement one or more aspects or elements of the above-described methods and/or systems. The computing environment 300 of FIG. 3 may be used by, or incorporated into, one or more elements of the system 100 (FIG. 1). For example, the computing environment 300 may be used to implement the client device 102 and/or the server device 104. The computing environment 300 may be used or included as a client, network server, application server, or database management system or other data store manager, of any of the aforementioned elements or system components. The computing environment 300 may be used to implement one or more of the acts described in connection with FIG. 2.

The computing environment 300 includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The units, components, and other hardware of computer 310 may vary from the example shown.

Computer 310 typically includes a variety of computer readable storage media configured to store instructions and other data. Such computer readable storage media may be any available media that may be accessed by computer 310 and includes both volatile and nonvolatile media, removable and non-removable media. By way of example, and not limitation, such computer readable storage media may include computer storage media as distinguished from communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may accessed by computer 310.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337. For example, one or more of the application programs 335 may be directed to implementing the client instructions 132 (FIG. 1), the user interface instructions 134 (FIG. 1), and/or one or more of the other instruction sets described above. Alternatively or additionally, the client instructions 132 and/or the user interface instructions 134 may be implemented via one or more of the other program modules 336. In this or another example, any one or more the instruction sets in the above-described memories or data storage devices may be stored as program data 337.

Any one or more of the operating system 334, the application programs 335, the other program modules 336, and the program data 337 may be stored on, and implemented via, a system on a chip (SOC). Any of the above-described modules may be implemented via one or more SOC devices. The extent to which the above-described modules are integrated in a SOC or other device may vary.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. These components may either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and pointing device 361, commonly referred to as a mouse, trackball or touch pad. Other input devices (not shown) may include a microphone (e.g., for voice control), touchscreen (e.g., for touch-based gestures and other movements), ranger sensor or other camera (e.g., for gestures and other movements), joystick, game pad, satellite dish, and scanner. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

The computing environment 300 of FIG. 3 is only one example of a suitable computing environment and is not intended to suggest any limitation as to the scope of use or functionality of the technology herein. Neither should the computing environment 300 be interpreted as having any dependency or requirement relating to any one or combination of components illustrated in the exemplary operating environment 300.

The technology described herein is operational with numerous other general purpose or special purpose computing system environments or configurations. Examples of well-known computing systems, environments, and/or configurations that may be suitable for use with the technology herein include, but are not limited to, personal computers, server computers (including server-client architectures), hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A computer-implemented method for specifying interval data, the computer-implemented method comprising:
displaying, via a user interface, a slider row of user select buttons, the slider row being configured to support selection of a range term of the interval data;
receiving first data indicative of a first touch input via the user interface directed to a respective one of the user select buttons in the slider row to specify a value for the range term in accordance with the respective user select button;
displaying, via the user interface, a plurality of user select range composition buttons;
receiving second data indicative of a second touch input via the user interface directed to a respective one of the plurality of user select range composition buttons to determine whether the interval data includes a further range term to be specified; and
storing, with a processor, the interval data in a memory in accordance with the first data and the second data.

2. The computer-implemented method of claim 1, wherein one of the plurality of the user select composition buttons is configured to commit the value to the interval data.

3. The computer-implemented method of claim 1, wherein the plurality of the user select composition buttons comprises a range composition control button configured to create the further range term for the interval data.

4. The computer-implemented method of claim 1, wherein the plurality of the user select composition buttons comprises a range composition control button to support concatenation of multiple ranges.

5. The computer-implemented method of claim 1, wherein the plurality of the user select composition buttons comprises a range composition control button configured to establish a relationship between the range term and the further range term.

6. The computer-implemented method of claim 1, wherein the plurality of the user select composition buttons comprises a range term commit button configured to commit the range term to the interval data.

7. The computer-implemented method of claim 6, wherein the second touch input is directed to the range term commit button such that the interval data specifies a single range term.

8. The computer-implemented method of claim 1, further comprising displaying, via the user interface, the value for the range term upon receipt of the first data.

9. The computer-implemented method of claim 1, wherein the slider row is one of a plurality of slider rows, each slider row being directed to specifying a different level of granularity for the interval data.

10. An apparatus for specifying interval data, the system comprising:
a memory in which user interface instructions are stored;
a processor coupled to the memory and configured to execute the user interface instructions to:
render a user interface comprising a plurality of slider rows, each slider row comprising a set of user select buttons and being configured to support selection of a range term of the interval data, and further comprising a plurality of user select range composition buttons;
receive, via the user interface, first data indicative of a first touch input directed to a respective one of the user select buttons in one of the plurality of slider rows to specify a value for the range term in accordance with the respective user select button; and
receive, via the user interface, second data indicative of a second touch input directed to a respective one of the plurality of user select range composition buttons to determine whether the interval data includes a further range term to be specified; and
a display coupled to the processor to present the user interface.

11. The apparatus of claim 10, wherein the plurality of the user select composition buttons comprises a range composition control button configured to create the further range term for the interval data.

12. The apparatus of claim 10, wherein the plurality of the user select composition buttons comprises a range composition control button to support concatenation of multiple ranges.

13. The apparatus of claim 10, wherein the plurality of the user select composition buttons comprises a range composition control button configured to establish a relationship between the range term and the further range term.

14. The apparatus of claim 10, wherein the plurality of the user select composition buttons comprises a range term commit button configured to commit the range term to the interval data.

15. The apparatus of claim 14, wherein the second touch input is directed to the range term commit button such that the interval data specifies a single range term.

16. A computer program product comprising one or more computer-readable storage media in which computer-readable instructions are stored that, when executed by a processing system, direct the processing system to implement a method comprising:
rendering a user interface comprising a plurality of slider rows, each slider row comprising a set of user select buttons and being configured to support selection of a range term of the interval data, and further comprising a plurality of user select range composition control buttons;
receiving, via the user interface, first data indicative of a first touch input directed to a respective one of the user select buttons in one of the plurality of slider rows to specify a value for the range term in accordance with the respective user select button;
displaying, via the user interface, the value for the range term upon receipt of the first data;
receiving, via the user interface, second data indicative of a second touch input directed to a respective one of the plurality of user select range control buttons to determine whether the interval data includes a further range term to be specified; and
storing the interval data in a memory in accordance with the first data and the second data.

17. The computer program product of claim 16, wherein the plurality of user select range composition control buttons comprises a button configured to create the further range term for the interval data.

18. The computer program product of claim 16, wherein the plurality of user select range composition control buttons comprises a button to support concatenation of multiple ranges.

19. The computer program product of claim 16, wherein the plurality of user select range composition control buttons comprises a button configured to establish a relationship between the range term and the further range term.

20. The computer program product of claim 19, wherein the second touch input is directed to the button such that the interval data specifies a single range term.
